(19) United States
(12) Patent Application Publication
(10) Pub. No.: US 2016/0304081 A1
(43) Pub. Date: Oct. 20, 2016

(54) HYBRID VEHICLE

(71) Applicant: TOYOTA JIDOSHA KABUSHIKI KAISHA, Toyota-shi (JP)

(72) Inventor: Yasutaka TSUCHIDA, Toyota-shi (JP)

(73) Assignee: TOYOTA JIDOSHA KABUSHIKI KAISHA, Toyota-shi (JP)

(21) Appl. No.: 15/098,395

(22) Filed: Apr. 14, 2016

(30) Foreign Application Priority Data
Apr. 15, 2015 (JP) 2015-83505

(51) Int. Cl. B60W 20/13; B60K 6/26; B60K 6/365; B60W 10/06; B60W 10/08

(52) U.S. Cl. CPC B60W 20/13; B60W 10/06; B60W 10/08; B60K 6/365; B60K 6/26; B60W 2710/083; B60W 2710/0644; Y10S 903/93; Y10S 903/906; Y10S 903/91; B60Y 2200/92; B60Y 2300/60; B60Y 2300/43

(57) ABSTRACT

In the process of stopping an engine, upon satisfaction of an increase start condition that rotation speed Ne of the engine becomes equal to or lower than a predetermined rotation speed Nref1, a rate value Rup is set to have an increasing tendency with a decrease in minimum torque Tspmin (with an increase as the absolute value). A rate process using the set rate value Rup is performed to increase a motoring torque Tsp (motor torque command) from the negative minimum torque Tspmin.

This application claims priority to Japanese Patent Application No. 2015-83505 filed 15 Apr. 2015, the contents of which is incorporated herein by reference.

### TECHNICAL FIELD

The present invention relates to a hybrid vehicle and more specifically to a hybrid vehicle equipped with an engine, a motor and a battery.

### BACKGROUND ART

In the configuration of a hybrid vehicle that a damper linked with an engine, a first motor and a driveshaft linked with an axle are respectively connected with a carrier, a sun gear and a ring gear of a planetary gear and that a second motor is connected with the driveshaft, a proposed technique controls the first motor to output a negative torque (torque in a direction of reducing the rotation speed of the engine) in the process of stopping the engine (for example, Patent Literature 1). In the process of stopping the engine, the hybrid vehicle of this configuration controls the first motor to output a negative predetermined torque until satisfaction of a condition that the rotation speed of the engine becomes equal to or lower than a predetermined rotation speed and that the crank angle of the engine enters a predetermined range, and controls the first motor to decrease the magnitude of torque output from the first motor from the magnitude of the predetermined torque by a rate process using a rate value after satisfaction of the condition. Using this condition suppresses generation of relatively high vibration in the process of stopping the engine.

### CITATION LIST

### Patent Literature

PTL 1: JP 2014-104909A

### SUMMARY OF INVENTION

### Technical Problem

The hybrid vehicle of the above configuration, however, uses a fixed value as the rate value to decrease the magnitude of the torque output from the motor in the process of stopping the engine. Depending on the decrease rate in rotation speed of the engine, this is likely to cause abnormal noise such as gear rattle of the planetary gear due to a torque caused by, for example, torsion of the damper or to decrease the rotation speed of the engine across the value 0 to a negative value (i.e., to cause reverse rotation of the engine).

With regard to the hybrid vehicle, an object of the invention is thus to reduce abnormal noise in a mechanical structure linked with a predetermined shaft on an axle side that is connected with an output shaft of an engine via a torsion element and to suppress reverse rotation of the engine in the process of stopping the engine.

### Solution of Problem

In order to achieve the object described above, the hybrid vehicle of the invention may be implemented by the following aspects.

According to one aspect of the invention, there is provided a first hybrid vehicle including: an engine that is configured to have an output shaft connected via a torsion element with a predetermined shaft on a side of an axle; a motor that is configured to input and output power from and to the predetermines shaft; a battery that is configured to transmit electric power to and from the motor; and a controller that is configured to perform a stop-time control by the motor in a process of stopping the engine, the stop-time control controlling the motor to output a first torque in a direction of reducing rotation speed of the engine until satisfaction of a condition that the rotation speed of the engine becomes equal to or lower than a predetermined rotation speed, and controlling the motor to decrease magnitude of torque output from the motor from magnitude of the first torque after satisfaction of the condition, wherein the first torque is a torque adjusted such that a crank angle of the engine enters a predetermined range upon satisfaction of the condition, and after satisfaction of the condition, the stop-time control controls the motor such as to provide a larger decrement in magnitude of the torque output from the motor per unit time with respect to a larger magnitude of the first torque than a decrement with respect to a smaller magnitude of the first torque, and/or such as to provide a larger decrement in magnitude of the torque output from the motor per unit time with respect to a shorter time period until satisfaction of the condition since a start of the stop-time control than a decrement with respect to a longer time period.

The first hybrid vehicle of this aspect performs the stop-time control by the motor in the process of stopping the engine. The stop-time control controls the motor to output the first torque that is a torque in the direction of reducing the rotation speed of the engine and is adjusted to enter the crank angle of the engine to a predetermined range, until satisfaction of the condition that the rotation speed of the engine becomes equal to or lower than the predetermined rotation speed (hereinafter referred to as “first condition”). After satisfaction of the first condition, the stop-time control controls the motor to decrease the magnitude of the torque output from the motor from the magnitude of the first torque. After satisfaction of the first condition, the stop-time control controls the motor such as to provide a larger decrement in magnitude of the torque output from the motor per unit time with respect to a larger magnitude of the first torque than a decrement with respect to a smaller magnitude of the first torque, and/or such as to provide a larger decrement in magnitude of the torque output from the motor per unit time with respect to a shorter time period until satisfaction of the first condition since a start of the stop-time control than a decrement with respect to a longer time period. In the process of stopping the engine, the larger magnitude of the first torque is expected to provide a greater reduction in rotation speed of the engine per unit time and to provide a shorter time period until satisfaction of the first condition since a start of the stop-time control, compared with the smaller magnitude of the first torque. Accordingly, setting a relatively small decrement in magnitude of the torque output from the motor per unit time at the relatively small magnitude of the first torque or at the relatively long time period until satisfaction of the first condition since a start of the stop-time control suppresses the torque output from the motor from approaching to the value 0 when the rotation speed of the engine is a relatively high rotation speed in a range of not higher than the predetermined rotation speed (rotation speed relatively close to the resonance range of the engine). This reduces abnormal noise such as gear rattle of a mechanical structure linked with the predetermined shaft on the axle side due to a torque caused by, for example, a torsion of a torsion element. Setting a relatively large decrement in magnitude of the torque output from the motor per unit time at the relatively large magnitude of the first torque or at the relatively short time period until satisfaction of the first condition since a start of the stop-time control, on the other hand, suppresses reverse rotation of the engine. The “predetermined range” may be set, for example, to control the vibration generated in the vehicle at the time of starting decreasing the magnitude of the torque output from the motor from the magnitude of the first torque upon satisfaction of the first condition to or below an allowable upper limit vibration level.

According to another aspect of the invention, there is provided a second hybrid vehicle including: an engine that is configured to have an output shaft connected via a torsion element with a predetermined shaft on a side of an axle; a motor that is configured to input and output power from and to the predetermines shaft; a battery that is configured to transmit electric power to and from the motor; and a controller that is configured to perform a stop-time control by the motor in a process of stopping the engine, the stop-time control controlling the motor to output a predetermined torque in a direction of reducing rotation speed of the engine until satisfaction of a condition that the rotation speed of the engine becomes equal to or lower than a predetermined rotation speed and that a crank angle of the engine enters a predetermined range, and controlling the motor to decrease magnitude of torque output from the motor from magnitude of the predetermined torque after satisfaction of the condition, wherein after satisfaction of the condition, the stop-time control controls the motor such as to provide a larger decrement in magnitude of the torque output from the motor per unit time with respect to a lower rotation speed or a lower rotational acceleration of the engine upon satisfaction of the condition than a decrement with respect to a higher rotation speed or a higher rotational acceleration, and/or such as to provide a larger decrement in magnitude of the torque output from the motor per unit time with respect to a longer time period until satisfaction of the condition since a start of the stop-time control than a decrement with respect to a shorter time period.

The second hybrid vehicle of the invention performs the stop-time control by the motor in the process of stopping the engine. The stop-time control controls the motor to output the predetermined torque in the direction of reducing the rotation speed of the engine until satisfaction of the condition that the rotation speed of the engine becomes equal to or lower than the predetermined rotation speed and that the crank angle of the engine enters the predetermined range (hereinafter referred to as “second condition”). After satisfaction of the second condition, the stop-time control controls the motor to decrease the magnitude of the torque output from the motor from the magnitude of the predetermined torque. After satisfaction of the second condition, the stop-time control controls the motor such as to provide a larger decrement in magnitude of the torque output from the motor per unit time with respect to a lower rotation speed or a lower rotational acceleration of the engine than a decrement with respect to a higher rotation speed or a higher rotational acceleration, and/or such as to provide a larger decrement in magnitude of the torque output from the motor per unit time with respect to a longer time period until satisfaction of the second condition since a start of the stop-time control than a decrement with respect to a shorter time period. In the process of stopping the engine, setting a relatively small decrement in magnitude of the torque output from the motor per unit time at the relatively high rotation speed or the relatively high rotational acceleration of the engine upon satisfaction of the second condition or at the relatively short time period until satisfaction of the second condition since a start of the stop-time control suppresses the torque output from the motor from approaching to the value 0 when the rotation speed of the engine is a relatively high rotation speed in a range of not higher than the predetermined rotation speed (rotation speed relatively close to the resonance range of the engine). This reduces abnormal noise such as gear rattle of a mechanical structure linked with the predetermined shaft on the axle side due to a torque caused by, for example, a torsion of a torsion element. Setting a relatively large decrement in magnitude of the torque output from the motor per unit time at the relatively low rotation speed or the relatively low rotational acceleration of the engine upon satisfaction of the second condition or at the relatively long time period until satisfaction of the second condition since a start of the stop-time control, on the other hand, suppresses reverse rotation of the engine. The “predetermined range” may be set, for example, to control the vibration generated in the vehicle at the time of starting decreasing the magnitude of the torque output from the motor from the magnitude of the predetermined torque upon satisfaction of the second condition to or below an allowable upper limit vibration level.

### BRIEF DESCRIPTION OF DRAWINGS

FIG. 1 is a configuration diagram illustrating the schematic configuration of a hybrid vehicle according to a first embodiment of the present invention;

FIG. 2 is a flowchart showing one example of a stop-time control routine performed by an HVECU according to the first embodiment;

FIG. 3 is a diagram illustrating one example of a relationship between vehicle speed V and required torque Tr* with regard to various accelerator positions Acc;

FIG. 4 is a chart illustrating one example of a collinear diagram that shows a dynamic relationship between rotation speed and torque with regard to rotational elements of a planetary gear in the process of stopping an engine;

FIG. 5 is a flowchart showing one example of a motoring torque setting routine performed by the HVECU according to the first embodiment;

FIG. 6 is a diagram illustrating one example of a relationship between a minimum torque Tspmin and a rate value Rup;

FIG. 7 is a chart showing one example of time changes of torque Tm1 of a motor MG1 and rotation speed Ne and crank angle θcr of the engine in the process of stopping the engine;

FIG. 8 is a flowchart showing a motoring torque setting routine according to a modification of the first embodiment;

FIG. 9 is a diagram illustrating one example of a relationship between a motoring time to upon satisfaction of an increase start condition and the rate value Rup;

FIG. 10 is a flowchart showing one example of a motoring torque setting routine performed by the HVECU according to a second embodiment;

FIG. 11 is a diagram illustrating one example of a relationship between a rotation speed Ne of the engine upon satisfaction of an increase start condition and the rate value Rup;

FIG. 12 is a chart showing one example of time changes of torque Tm1 of a motor MG1 and rotation speed Ne and crank angle θcr of the engine in the process of stopping the engine;

FIG. 13 is a flowchart showing a motoring torque setting routine according to a modification of the second embodiment;

FIG. 14 is a flowchart showing a motoring torque setting routine according to another modification of the second embodiment;

FIG. 15 is a flowchart showing a motoring torque setting routine according to another modification of the second embodiment;

FIG. 16 is a diagram illustrating one example of a relationship between a rotational acceleration Ae of the engine upon satisfaction of the increase start condition and the rate value Rup;

FIG. 17 is a diagram illustrating one example of a relationship between a motoring time tb upon satisfaction of the increase start condition and the rate value Rup;

FIG. 18 is a diagram illustrating one example of a relationship between a minimum torque time tc upon satisfaction of the increase start condition and the rate value Rup;

FIG. 19 is a configuration diagram illustrating the schematic configuration of a hybrid vehicle of a modification;

FIG. 20 is a configuration diagram illustrating the schematic configuration of a hybrid vehicle of another modification; and

FIG. 21 is a configuration diagram illustrating the schematic configuration of a hybrid vehicle of another modification.

### DESCRIPTION OF EMBODIMENTS

The following describes some aspects of the invention with reference to embodiments.

### First Embodiment

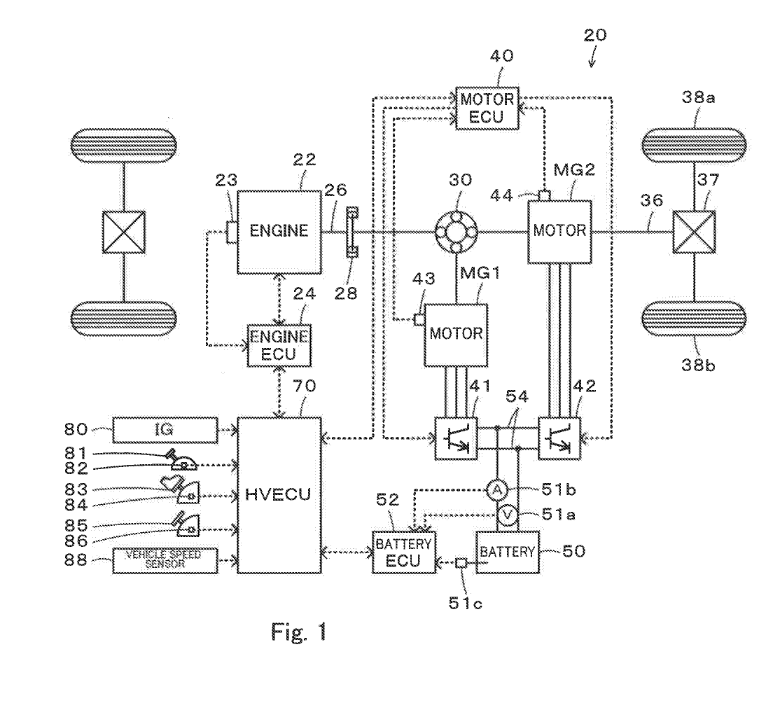

FIG. 1 is a configuration diagram illustrating the schematic configuration of a hybrid vehicle 20 according to a first embodiment of the present invention. As illustrated, the hybrid vehicle 20 of the first embodiment includes an engine 22, a planetary gear 30, motors MG1 and MG2, inverters 41 and 42, a battery 50 and a hybrid electronic control unit (hereinafter referred to as “HVECU”) 70.

The engine 22 is configured as a four-cylinder internal combustion engine that uses, for example, gasoline or light oil as fuel to output power. This engine 22 is operated and controlled by an engine electronic control unit (hereinafter referred to as “engine ECU”) 24.

The engine ECU 24 is implemented by a CPU-based microprocessor and includes a ROM that stores processing programs, a RAM that temporarily stores data, input and output ports and a communication port other than the CPU, although not being illustrated. The engine ECU 24 inputs, via its input port, signals from various sensors required for operation control of the engine 22. The signals from various sensors include, for example, a crank angle θcr from a crank position sensor 23 configured to detect the rotational position of a crankshaft 26 of the engine 22 and a throttle position TH from a throttle valve position sensor configured to detect the position of a throttle valve. The engine ECU 24 outputs, via its output port, various control signals for operation control of the engine 22. The various control signals include, for example, a control signal to a fuel injection valve, a control signal to a throttle motor configured to adjust the position of the throttle valve and a control signal to an ignition coil integrated with an igniter. The engine ECU 24 is connected with the HVECU 70 via the respective communication ports. The engine ECU 24 performs operation control of the engine 22, in response to control signals from the HVECU 70. The engine ECU 24 also outputs data regarding the operating conditions of the engine 22 to the HVECU 70 as appropriate. The engine ECU 24 computes a rotation speed Ne of the engine 22, based on the crank angle θcr from the crank position sensor 23.

The planetary gear 30 is configured as a single pinion-type planetary gear mechanism. The planetary gear 30 includes a sun gear that is connected with a rotor of the motor MG1. The planetary gear 30 also includes a ring gear that is connected with a driveshaft 36 linked with drive wheels 38a and 38b via a differential gear 37 and is connected with a rotor of the motor MG2. The planetary gear 30 also includes a carrier that is connected with the crankshaft 26 of the engine 22 via a damper 28 as torsion element. A shaft arranged to connect the damper 28 with the carrier of the planetary gear 30 corresponds to the “predetermined shaft” in the claims.

The motor MG1 is configured, for example, as a synchronous motor generator. The motor MG1 includes the rotor that is connected with the sun gear of the planetary gear 30 as described above. The motor MG2 is also configured, for example, as a synchronous motor generator. The motor MG2 includes the rotor that is connected with the driveshaft 36 as described above. The inverters 41 and 42 as well as the battery 50 are connected with power lines 54. The motors MG1 and MG2 are rotated and driven by switching control of a plurality of switching elements (not shown) of the inverters 41 and 42 by a motor electronic control unit (hereinafter referred to as “motor ECU”) 40.

The motor ECU 40 is implemented by a CPU-based microprocessor and includes a ROM that stores processing programs, a RAM that temporarily stores data, input and output ports and a communication port other than the CPU, although not being illustrated. The motor ECU 40 inputs, via its input port, signals from various sensors required for drive control of the motors MG1 and MG2. The signals from various sensors include, for example, rotational positions θm1 and θm2 from rotational position detection sensors 43 and 44 configured to detect the rotational positions of the rotors of the motors MG1 and MG2 and phase currents from current sensors configured to detect electric currents flowing through the respective phases of the motors MG1 and MG2. The motor ECU 40 outputs, via its output port, for example, switching control signals to the switching elements (not shown) of the inverters 41 and 42. The motor ECU is connected with the HVECU 70 via the respective communication ports. The motor ECU 40 performs drive control of the motors MG1 and MG2 in response to control signals from the HVECU 70. The motor ECU 40 also outputs data regarding the driving conditions of the motors MG1 and MG2 to the HVECU 70 as appropriate. The motor ECU 40 computes rotation speeds Nm1 and Nm2 of the motors MG1 and MG2, based on the rotational positions θm1 and θm2 of the rotors of the motors MG1 and MG2 from the rotational position detection sensors 43 and 44.

The battery 50 is configured, for example, as a lithium ion secondary battery or a nickel hydride secondary battery. This battery 50 as well as the inverters 41 and 42 is connected with the power lines 54 as described above. The battery 50 is under management of a battery electronic control unit (hereinafter referred to as “battery ECU”) 52.

The battery ECU 52 is implemented by a CPU-based microprocessor and includes a ROM that stores processing programs, a RAM that temporarily stores data, input and output ports and a communication port other than the CPU, although not being illustrated. The battery ECU 52 inputs, via its input port, signals from various sensors required for management of the battery 50. The signals from various sensors include, for example, a battery voltage Vb from a voltage sensor 51a placed between terminals of the battery 50, a battery current Ib from a current sensor 51b mounted to an output terminal of the battery 50, and a battery temperature Tb from a temperature sensor 51c mounted to the battery 50. The battery ECU 52 is connected with the HVECU 70 via the respective communication ports. The battery ECU 52 outputs data regarding the conditions of the battery 50 to the HVECU 70 as appropriate. The battery ECU 52 computes a state of charge SOC, based on an integrated value of the battery current Ib from the current sensor 51b. The state of charge SOC denotes a ratio of power capacity dischargeable from the battery 50 to the entire capacity of the battery 50. The battery ECU 52 also computes input and output limits Win and Wout, based on the computed state of charge SOC and the battery temperature Tb from the temperature sensor 51c. The input and output limits Win and Wout denote maximum allowable electric powers chargeable into and dischargeable from the battery 50.

The HVECU 70 is implemented by a CPU-based microprocessor and includes a ROM that stores processing programs, a RAM that temporarily stores data, input and output ports and a communication port other than the CPU, although not being illustrated. The HVECU 70 inputs, via its input port, signals from various sensors. The signals from various sensors include, for example, an ignition signal from an ignition switch 80, a shift position SP from a shift position sensor 82 configured to detect the operational position of a shift lever 81, an accelerator position Acc from an accelerator pedal position sensor 84 configured to detect the depression amount of an accelerator pedal 83, a brake pedal position BP from a brake pedal position sensor 86 configured to detect the depression amount of a brake pedal 85, and a vehicle speed V from a vehicle speed sensor 88. As described above, the HVECU 70 is connected with the engine ECU 24, the motor ECU 40 and the battery ECU 52 via the communication ports. The HVECU 70 transmits various control signals and data to and from the engine ECU 24, the motor ECU 40 and the battery ECU 52.

The hybrid vehicle 20 of the first embodiment having the above configuration runs in a drive mode, such as hybrid drive mode (HV drive mode) or an electric drive mode (EV drive mode). The HV drive mode denotes a drive mode in which the hybrid vehicle 20 is driven with operation of the engine 22. The EV drive mode denotes a drive mode in which the hybrid vehicle 20 is driven with stopping operation of the engine 22.

In the HV drive mode the HVECU 70 first sets a required torque Tr* required for running (to be output to the driveshaft 36), based on the accelerator position Acc from the accelerator pedal position sensor 84 and the vehicle speed V from the vehicle speed sensor 88. The HVECU 70 subsequently multiplies the set required torque Tr* by a rotation speed Nr of the driveshaft 36 to calculate a driving power Pdrv* required for running. The rotation speed Nr of the driveshaft 36 used herein may be the rotation speed Nm2 of the motor MG2 or a rotation speed calculated by multiplying the vehicle speed V by a conversion efficiency. The HVECU 70 subtracts a charge-discharge power demand Pb* of the battery 50 (that takes a positive value in the case of discharging from the battery 50) from the driving power Pdrv* to calculate a required power Pe* required for the vehicle. The HVECU 70 then sets a target rotation speed Ne* and a target torque Te* of the engine 22 and torque commands Tm1* and Tm2* of the motors MG1 and MG2 such as to cause the required power Pe* to be output from the engine 22 and cause the required torque Tr* to be output to the driveshaft 36 within the range of the input and output limits Win and Wout of the battery 50. The HVECU 70 then sends the target rotation speed Ne* and the target torque Te* of the engine 22 to the engine ECU 24, while sending the torque commands Tm1* and Tm2* of the motors MG1 and MG2 to the motor ECU 40. When receiving the target rotation speed Ne* and the target torque Te* of the engine 22, the engine ECU 24 performs intake air flow control, fuel injection control and ignition control of the engine 22 so as to operate the engine 22 based on the received target rotation speed Ne* and the received target torque Te*. When receiving the torque commands Tm1* and Tm2* of the motors MG1 and MG2, the motor ECU 40 performs switching control of the switching elements of the inverters 41 and 42 so as to drive the motors MG1 and MG2 with the torque commands Tm1* and Tm2*. When a stop condition of the engine 22 is satisfied in the HV drive mode, for example, when the required power Pe* becomes equal to or less than a stop threshold value Pstop, the hybrid vehicle 20 stops operation of the engine 22 and shifts the drive mode to the EV drive mode.

In the EV drive mode, the HVECU 70 first sets the required torque Tr*, as in the case of the HV drive mode. The HVECU 70 subsequently sets the torque command Tm1* of the motor MG1 to value 0. The HVECU 70 sets the torque command Tm2* of the motor MG2 such as to output the required torque Tr* to the driveshaft 36 in the range of the input limit Win and the output limit Wout of the battery 50. The HVECU 70 then sends the torque commands Tm1* and Tm2* of the motors MG1 and MG2 to the motor ECU 40. When receiving the torque commands Tm1* and Tm2* of the motors MG1 and MG2, the motor ECU 40 performs switching control of the switching elements of the inverters 41 and 42 so as to drive the motors MG1 and MG2 with the torque commands Tm1* and Tm2*. When a start condition of the engine 22 is satisfied in the EV drive mode, for example, when the required power Pe* calculated as in the HV drive mode becomes equal to or greater than a start threshold value Pstart that is larger than the stop threshold value Pstop, the hybrid vehicle 20 starts operation of the engine 22 and shifts the drive mode to the HV drive mode.

The following describes the operations of the hybrid vehicle 20 of the first embodiment having the configuration described above or more specifically the operations to stop the engine 22. FIG. 22 is a flowchart showing one example of a stop-time control routine performed by the HVECU 70 of the first embodiment. This routine is performed when the stop condition of the engine 22 is satisfied during a run in the HV drive mode.

On start of the stop-time control routine, the HVECU 70 first sends a control signal for stopping fuel injection control and ignition control of the engine 22 to the engine ECU 24 (step S100). When receiving this control signal, the engine ECU 24 stops fuel injection control and ignition control of the engine 22.

The HVECU 70 subsequently inputs data required for control, for example, the accelerator position Acc, the vehicle speed V, the rotation speed Ne of the engine 22, the rotation speeds Nm1 and Nm2 of the motors MG1 and MG2 and the input and output limits Win and Wout of the battery 50 (step S110). The accelerator position Acc input here is the value detected by the accelerator pedal position sensor 84. The vehicle speed V input here is the value detected by the vehicle speed sensor 88. The rotation speed Ne of the engine 22 is the value that is computed based on the crank angle θcr of the engine 22 from the crank position sensor 23 and is input from the engine ECU 24 by communication. The rotation speeds Nm1 and Nm2 of the motors MG1 and MG2 are the values that are computed based on the rotational positions θm1 and θm2 of the rotors of the motors MG1 and MG2 from the rotational position detection sensors 43 and 44 and are input from the motor ECU 40 by communication. The input and output limits Win and Wout of the battery 50 are the values that are set based on the battery temperature Tb of the battery 50 from the temperature sensor 51c and the state of charge SOC of the battery 50 based on the battery current Ib of the battery 50 from the current sensor 51b and are input from the battery ECU 52 by communication.

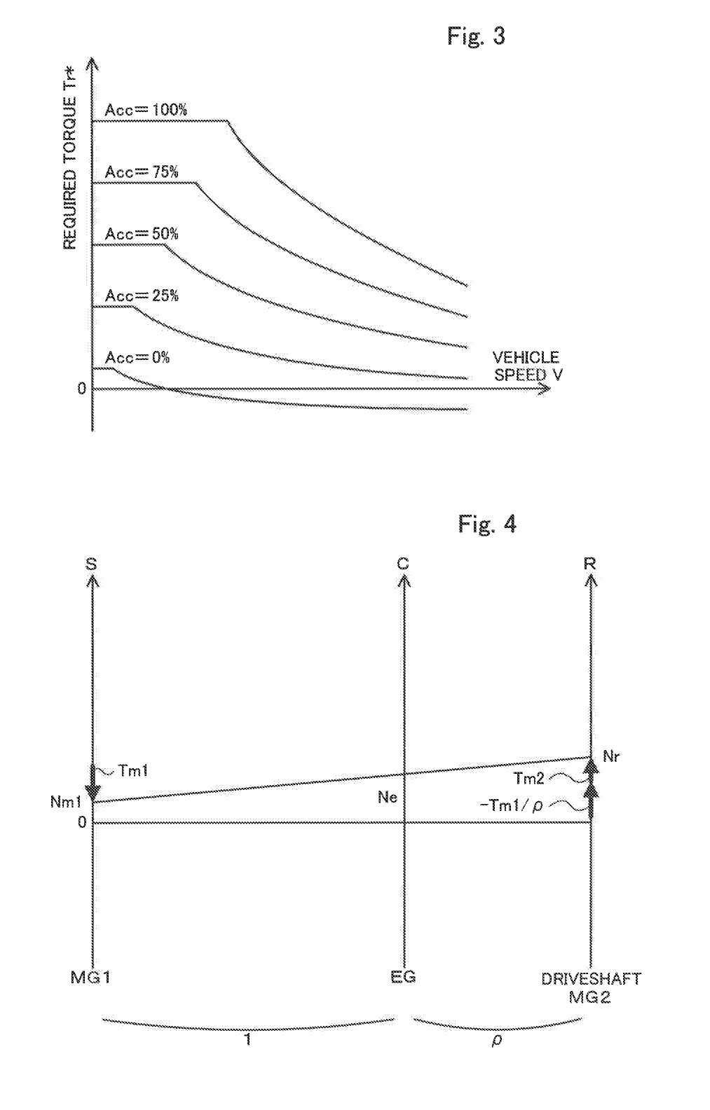

After inputting the data, the HVECU 70 refers to the input rotation speed Ne of the engine 22 to determine whether the engine 22 has stopped rotation (step S120). When it is determined that the engine 22 has not yet stopped rotation, the HVECU 70 sets a required torque Tr* required for driving (to be output to the driveshaft 36), based on the input accelerator position Acc and the input vehicle speed V (step S130). According to the first embodiment, a procedure of setting the required torque Tr* specifies and stores in advance a relationship between the vehicle speed V and the required torque Tr* with regard to various accelerator positions Acc in the form of a map in the ROM (not shown), and reads and sets the required torque Tr* corresponding to a given accelerator position Acc and a given vehicle speed V from this map. One example of the relationship between the vehicle speed V and the required torque Tr* with regard to various accelerator positions Acc is shown in FIG. 3.

The HVECU 70 subsequently sets a motoring torque Tsp to a torque command Tm1* of the motor MG1 (step S140). The motoring torque Tsp denotes a torque for motoring the engine 22 in the process of stopping the engine 22 and is a value set by a motoring torque setting routine (described later) as a torque in a direction of reducing the rotation speed Ne of the engine 22 (negative torque).

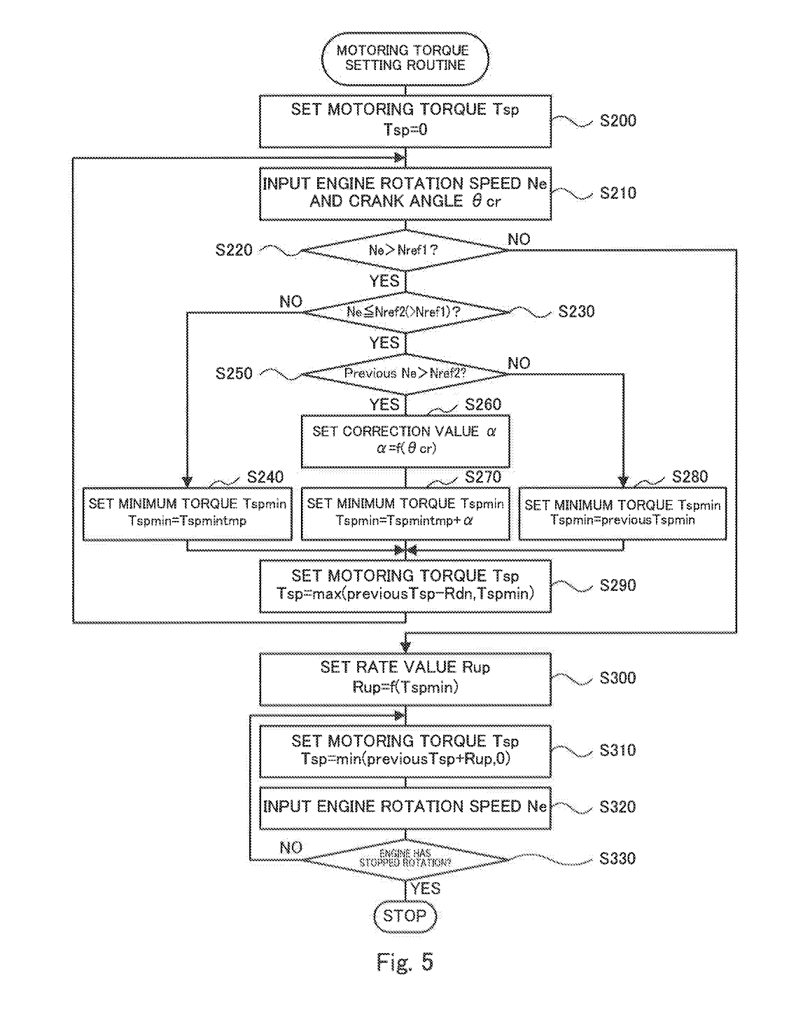

The HVECU 70 subtracts a torque that is output from the motor MG1 and is applied to the driveshaft 36 via the planetary gear 30 in the state that the motor MG1 is driven with the torque command Tm1*, from the required torque Tr*, so as to calculate a tentative torque Tm2tmp that is a provisional value of a torque command Tm2* of the motor MG2, according to Equation (1) given below (step S150). The HVECU 70 subsequently divides differences between the input and output limits Win and Wout of the battery 50 and power consumption (power generation) of the motor MG1, which is obtained by multiplying the torque command Tm1* of the motor MG1 by the current rotation speed Nm1, by the rotation speed Nm2 of the motor MG2, so as to calculate torque limits Tm2min and Tm2max as upper and lower limits of torque allowed to be output from the motor MG2, according to Equations (2) and (3) given below (step S160). The HVECU 70 then limits the tentative torque Tm2tmp with the torque limits Tm2min and Tm2max to set the torque command Tm2* of the motor MG2, according to Equation (4) given below (step S170). FIG. 4 is a chart illustrating one example of a collinear diagram that shows a dynamic relationship between rotation speed and torque with regard to the rotational elements of the planetary gear 30 in the process of stopping the engine 22. In the diagram, axis S on the left side shows the rotation speed of the sun gear that is equal to the rotation speed Nm1 of the motor MG1; axis C shows the rotation speed of the carrier that is equal to the rotation speed Ne of the engine 22; and axis R shows the rotation speed Nr of the ring gear that is equal to the rotation speed Nm2 of the motor MG2. Two thick arrows on the axis R indicate a torque that is output from the motor MG1 and is applied to a ring gear shaft 32a via the planetary gear 30 and a torque that is output from the motor MG2 and is applied to the driveshaft 36. Equation (1) is readily introduced from this collinear diagram.

Tm2tmp=Tr*+Tm1*/ρ (1)

Tm2min=(Win−Tm1*·Nm1)/Nm2 (2)

Tm2max=(Wout−Tm*·Nm1)/Nm2 (3)

Tm2*=max (min(Tm2tmp, Tm2max), Tm2min) (4)

After setting the torque commands Tm1* and Tm2* of the motors MG1 an MG2, the HVECU 70 sends the set torque commands Tm1* and Tm2* of the motors MG1 and MG2 to the motor ECU 40 (step S180) and returns to step S110. When receiving the torque commands Tm1* and Tm2* of the motors MG1 and MG2, the motor ECU 40 performs switching control of the switching elements of the inverters 41 and 42 to drive the motors MG1 and MG2 with the torque commands Tm1* and Tm2*. When it is determined at step S120 that the engine 22 has stopped rotation in the course of repetition of the processing of steps S110 to S180, the HVECU 70 terminates this routine.

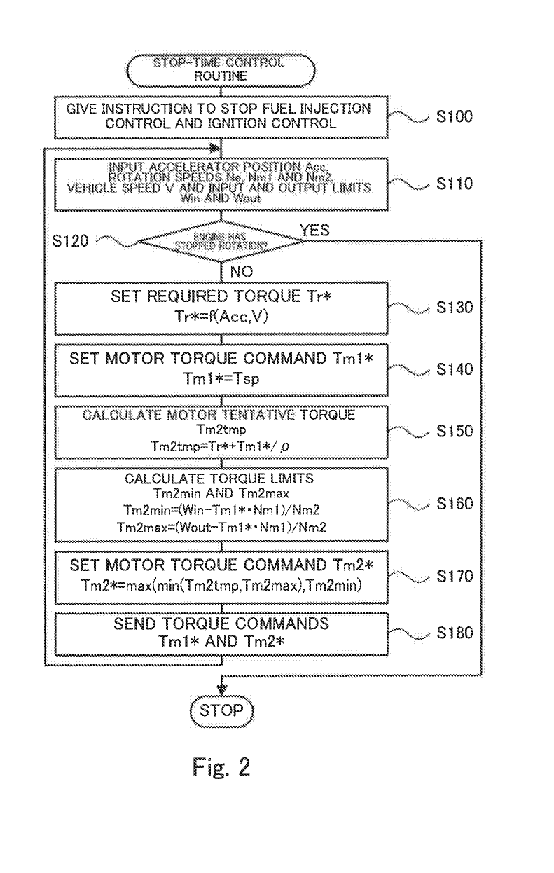

The following describes a process of setting the motoring torque Tsp used at step S140 in the above stop-time control routine. FIG. 5 is a flowchart showing one example of a motoring torque setting routine performed by the HVECU 70 of the first embodiment. This routine is performed in parallel with the stop-time control routine of FIG. 2 when the stop condition of the engine 22 is satisfied during a run in the HV drive mode.

On start of the motoring torque setting routine, the HVECU 70 first sets value 0 to the motoring torque Tsp (step S200) and subsequently inputs the rotation speed Ne and the crank angle θcr of the engine 22 (step S210). The crank angle θcr of the engine 22 is the value that is detected by the crank position sensor 23 and is input from the engine ECU 24 by communication. The rotation speed Ne of the engine 22 is the value that is computed based on the crank angle θcr of the engine 22 and is input from the engine ECU 24 by communication. The first embodiment employs the four-cylinder engine 22, so that the crank angle θcr is expressed in the range of −90° to 90° (repetitively changed in this range) on the assumption that the top dead center of the compression stroke in each cylinder of the engine 22 is set to 0°.

After inputting the data, the HVECU 70 refers to the input rotation speed Ne of the engine 22 to determine whether an increase start condition of the motoring torque Tsp is satisfied (step S220). The increase start condition denotes a condition to start increasing the motoring torque Tsp from a minimum torque Tspmin (start decreasing as the absolute value) and is a condition that the rotation speed Ne of the engine 22 is equal to or lower than a predetermined rotation speed Nref1 in the first embodiment. The minimum torque Tspmin denotes a minimum value of the motoring torque Tsp (maximum value as the absolute value) and will be described later in detail. The predetermined rotation speed Nref1 is set to be a lower rotation speed than a resonance range of the engine 22 (for example, 450 rpm to 650 rpm) and may be, for example, 300 rpm, 350 rpm or 400 rpm.

When the increase start condition is not satisfied at step S220, the HVECU 70 compares the rotation speed Ne of the engine 22 with a predetermined rotation speed Nref2 that is higher than the predetermined rotation speed Nref1 (step S230). The predetermined rotation speed Nref2 denotes a criterion rotation speed to determine whether a relatively small (relatively large as the absolute value) base value Tspmintmp in a negative range (in the direction of reducing the rotation speed Ne of the engine 22) is to be set to the minimum torque Tspmin and may be, for example, 800 rpm, 850 rpm or 900 rpm.

When the rotation speed Ne of the engine 22 is higher than the predetermined rotation speed Nref2, the HVECU 70 sets the base value Tspmintmp to the minimum torque Tspmin (step S240), sets the motoring torque Tsp with limiting a difference (previous Tsp−Rdn) by subtraction of a rate value Rdn from the previously set motoring torque (previous Tsp) with the minimum torque Tspmin (lower limit guarding) according to Equation (5) given below (step S290) and then returns to step S210. The rate value Rdn denotes a rate value in the direction of decreasing the motoring torque Tsp (increasing as the absolute value)

Tsp=max (previous Tsp−Rdn, Tspmin) (5)

When the rotation speed Ne of the engine 22 becomes equal to or lower than the predetermined rotation speed Nref2 at step S230 as the result of repetition of the processing of steps S210 to S240 and S290, the HVECU 70 compares the previous rotation speed Ne of the engine 22 (previous Ne) with the predetermined rotation speed Nref2 (step S250). This comparison aims to determine whether it is immediately after a decrease of the rotation speed Ne of the engine 22 to or below the predetermined rotation speed Nref2.

When the previous rotation speed Ne of the engine 22 (previous Ne) is higher than the predetermined rotation speed Nref2 at step S250, the HVECU 70 determines that it is immediately after a decrease of the rotation speed Ne of the engine 22 to or below the predetermined rotation speed Nref2. The HVECU 70 subsequently sets a correction value α based on the crank angle θcr of the engine 22 (step S260), sets a sum (Tspmintmp+α) by addition of the set correction value α to the base value Tspmintmp to the minimum torque Tspmin (step S270), sets the motoring torque Tsp according to Equation (5) given above (step S290) and then returns to step S210. The processing of steps S260 and S270 changes the minimum torque Tspmin from the base value Tspmintmp to the sum (Tspmintmp+α). The correction value a denotes a torque for correcting the base value Tspmintmp such that the crank angle θcr of the engine 22 enters a predetermined range of θsp1 to θsp2 when the rotation speed Ne of the engine 22 reaches the predetermined rotation speed Nref1. The minimum torque Tspmin is accordingly set (adjusted) to make the crank angle θcr of the engine 22 enter the predetermined range of θsp1 to θsp2 when the rotation speed Ne of the engine 22 becomes equal to or lower than the predetermined rotation speed Nref1. The predetermined range of θsp1 to θsp2 denotes a range set in advance by experiment or by analysis such as to control the vibration generated in the vehicle at the time of starting increasing the motoring torque Tsp (starting decreasing as the absolute value) upon satisfaction of the increase start condition to or below an allowable upper limit vibration level and may be, for example, a range of −50 degrees, −45 degrees, −40 degrees to −30 degrees, −25 degrees or −20 degrees. According to the first embodiment, a procedure of setting the correction value a specifies and stores in advance a relationship between the correction value α and the crank angle θcr when the rotation speed Ne of the engine 22 becomes equal to or lower than the predetermined rotation speed Nref2 in the form of a map in the ROM (not shown), and reads and sets the correction value α corresponding to a given crank angle θcr from this map.

When the previous rotation speed Ne of the engine 22 (previous Ne) is equal to or lower than the predetermined rotation speed Nref2 at step S250, on the other hand, the HVECU 70 sets the previously set minimum torque Tspmin to the new minimum torque Tspmin (step S280), sets the motoring torque Tsp according to Equation (5) given above (step S290) and then returns to step S210. In other words, the motoring torque Tsp is set with the sum (Tspmintmp+α) set to the minimum torque Tspmin for a time period from a decrease of the rotation speed Ne of the engine 22 to or below the predetermined rotation speed Nref2 to a subsequent decrease of the rotation speed Ne of the engine 22 to or below the predetermined rotation speed Nref1.

According to the first embodiment, the above rate value Rdn is a value set in advance by experiment or by analysis such as to allow the motoring torque Tsp to reach the minimum torque Tspmin (=Tspmintmp+α) within a slightly shorter time period than a required time period until a decrease of the rotation speed Ne of the engine 22 to or below the predetermined rotation speed Nref1 since a start of the stop-time control by the motor MG1 (since a start of execution of this routine). Accordingly, in the case where the rotation speed Ne of the engine 22 is higher than the predetermined rotation speed Nref1, the HVECU 70 waits until the rotation speed Ne of the engine 22 becomes equal to or lower than the predetermined rotation speed Nref1, while performing the rate process using the rate value Rdn to decrease the motoring torque Tsp from the value 0 to the minimum torque Tspmin and keeping the motoring torque Tsp at the minimum torque Tspmin.

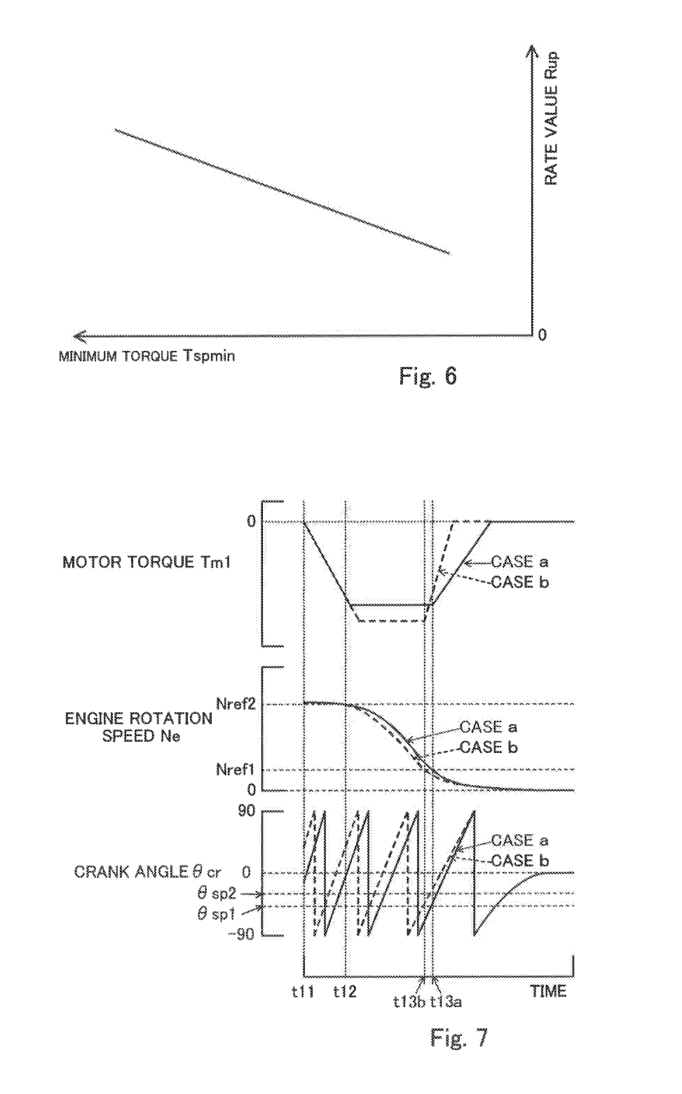

When the increase start condition is satisfied at step S220 as a result of repetition of the processing of steps S210 to S230, S250, S280 and S290, the HVECU 70 sets a rate value Rup based on the minimum torque Tspmin (i.e., the motoring torque Tsp upon satisfaction of the increase start condition) (step S300). The rate value Rup denotes a rate value in the direction of increasing the motoring torque Tsp (decreasing as the absolute value). According to the first embodiment, a procedure of setting the rate value Rup specifies and stores in advance a relationship between the minimum torque Tspmin and the rate value Rup in the form of a map in the ROM (not shown), and reads and sets the rate value Rup corresponding to a given minimum torque Tspmin from this map. One example of the relationship between the minimum torque Tspmin and the rate value Rup is shown in FIG. 6. As illustrated, the rate value Rup is set to provide a larger value with respect to the smaller minimum torque Tspmin (larger absolute value) than a value with respect to the larger minimum torque Tspmin and is more specifically set to have an increasing tendency with a decrease in minimum torque Tspmin as a whole. This results in providing a larger increment (decrement as the absolute value) of the motoring torque Tsp per unit time (for example, interval of execution of step S310 described later) with respect to the smaller minimum torque Tspmin than an increment with respect to the larger minimum torque Tspmin. This reason will be described later.

After setting the rate value Rup, the HVECU 70 sets the motoring torque Tsp with limiting a sum (previous Tsp+Rup) by addition of the rate value Rup to the previously set motoring torque (previous Tsp) with the value 0 (upper limit guarding) according to Equation (6) given below (step S310). The HVECU subsequently inputs the rotation speed Ne of the engine 22 (step S320) and refers to the input rotation speed Ne of the engine 22 to determine whether the engine 22 has stopped rotation (step S330). When it is determined that the engine 22 has not yet stopped rotation, the HVECU 70 returns to step S310. The processing of steps S310 to S330 waits until the engine 22 stops rotation, while performing the rate process using the rate value Rup to increase the motoring torque Tsp from the minimum torque Tspmin to the value 0 and keeping the motoring torque Tsp at the value 0. When it is determined at step S330 that the engine 22 has stopped rotation, the HVECU 70 terminates this routine.

Tsp−min (previous Tsp+Rup, 0) (5)

The following describes the reason why the rate value Rup is set at step S300 to provide a larger value with respect to the smaller minimum torque Tspmin (larger absolute value) than a value with respect to the larger minimum torque Tspmin or in other words, to provide a larger increment (decrement as the absolute value) of the motoring torque Tsp per unit time with respect to the smaller minimum torque Tspmin than an increment with respect to the larger minimum torque Tspmin. In the process of stopping the engine 22, the smaller minimum torque Tspmin is expected to provide a greater reduction in rotation speed Ne of the engine 22 per unit time, compared with the larger minimum torque Tspmin. Accordingly, setting a relatively small increment of the motoring torque Tsp (torque command Tm1* of the motor MG1) per unit time at the relatively large minimum torque Tspmin suppresses the motoring torque Tsp from approaching to the value 0 when the rotation speed Ne of the engine 22 is a relatively high rotation speed in a range of not higher than the predetermined rotation speed Nref1 (rotation speed relatively close to the resonance range of the engine). This reduces abnormal noise such as gear rattle of the planetary gear 30 due to a torque caused by, for example, torsion of the damper 28. Setting a relatively large increment of the motoring torque Tsp per unit time at the relatively small minimum torque Tspmin, on the other hand, suppresses the rotation speed Ne of the engine 22 from decreasing across the value 0 to a negative value or in other words, suppresses reverse rotation of the engine 22.

FIG. 7 is a chart showing one example of time changes of the torque Tm1 of the motor MG1 and the rotation speed Ne and the crank angle θcr of the engine 22 in the process of stopping the engine 22. In the chart, solid-line curves indicate a case a (the increase start condition is satisfied at a time t13a), and broken-line curves indicate a case b (the increase start condition is satisfied at a time t13b). As shown by the solid-line curves and the broken-line curves, when the stop condition of the engine 22 is satisfied at a time t11, the procedure performs the rate process using the rate value Rdn to decrease the torque Tm1 of the motor MG1 from the value 0 toward the minimum torque Tspmin (=Tspmintmp) (increase as the absolute value). When the rotation speed Ne of the engine 22 becomes equal to or lower than the predetermined rotation speed Nref2 at a time t12, the procedure changes the minimum torque Tspmin from the base value Tspmintmp to the sum (Tspmintmp+α) according to the crank angle θcr of the engine 22 at that moment. The procedure then performs the rate process using the rate value Rdn to decrease the torque Tm1 of the motor MG1 to the minimum torque Tspmin and keep the torque Tm1 at the minimum torque Tspmin. The increase start condition (condition that the rotation speed Ne of the engine 22 becomes equal to or lower than the predetermined rotation speed Nref1) is satisfied at the time t13a in the case a and at the time t13b in the case b. The procedure then waits until the engine 22 stops rotation, while performing the rate process using the rate value Rup to increase the torque Tm1 of the motor MG1 from the minimum torque Tspmin to the value 0 (decrease as the absolute value). According to the first embodiment, the rate value Rup is set to provide a larger value with respect to the smaller minimum torque Tspmin (larger absolute value) than a value with respect to the larger minimum torque Tspmin. This reduces abnormal noise such as gear rattle of the planetary gear 30 and suppresses reverse rotation of the engine 22 in the process of stopping the engine 22.

As described above, the hybrid vehicle 20 of the first embodiment starts increasing the motoring torque Tsp (torque command Tm1* of the motor MG1) from the negative minimum torque Tspmin, upon satisfaction of the increase start condition that the rotating speed Ne of the engine 22 becomes equal to or lower than the predetermined rotation speed Nref1, in the process of stopping the engine 22. The hybrid vehicle 20 increases the motoring torque Tsp (decreases as the absolute value) by the rate process using the rate value Rup that is set to provide a larger value with respect to the smaller minimum torque Tspmin (i.e., the motoring torque Tsp upon satisfaction of the increase start condition) than a value with respect to the larger minimum torque Tspmin. This results in providing a larger increment (decrement as the absolute value) of the motoring torque Tsp per unit time with respect to the smaller minimum torque Tspmin (larger absolute value) than an increment with respect to the larger minimum torque Tspmin in the process of increasing the motoring torque Tsp. As a result, this reduces abnormal noise such as gear rattle of the planetary gear 30 and suppresses reverse rotation of the engine 22 in the process of stopping the engine 22.

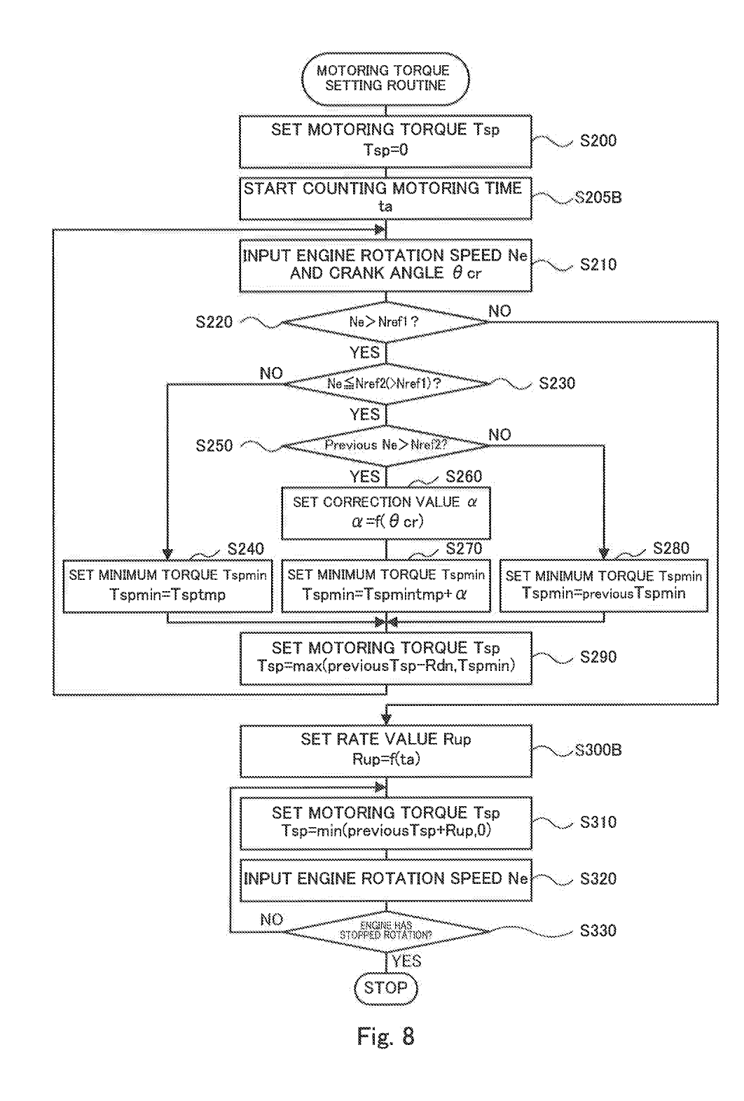

The hybrid vehicle 20 of the first embodiment performs the motoring torque setting routine of FIG. 5 in the process of stopping the engine 22. According to a modification, the hybrid vehicle may perform a motoring torque setting routine of FIG. 8. The motoring torque setting routine of FIG. 8 is similar to the motoring torque setting routine of FIG. 5, except addition of step S205B and replacement of step S300 with step S300B. The like steps in the motoring torque setting routine of FIG. 8 to those in the motoring torque setting routine of FIG. 5 are expressed by the like step numbers and are not specifically described.

In the motoring torque setting routine of FIG. 8, after the processing of step S200, the HVECU 70 starts counting a motoring time ta (step S205B). The motoring time ta denotes a time period since a start of the stop-time control by the motor MG1 (since a start of execution of the routines of FIGS. 2 and 8).

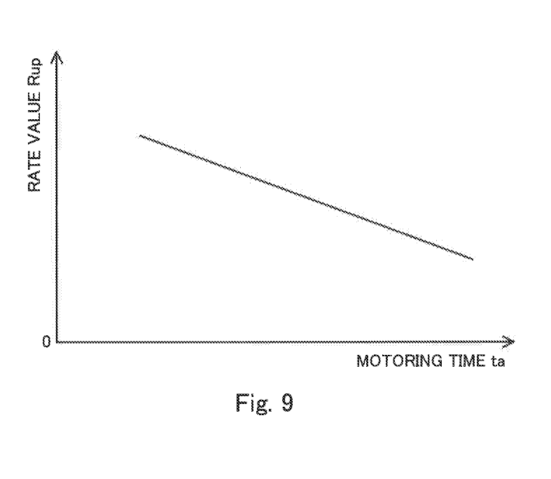

When the increase start condition is satisfied at step S220 as a result of repetition of the processing of steps S210 to S290, the HVECU 70 set the rate value Rup based on the motoring time ta at that moment (time period until satisfaction of the increase start condition since a start of the stop-time control by the motor MG1) (step S300B) and performs the processing of and after step S310. According to this modification, a procedure of setting the rate value Rup specifies and stores in advance a relationship between the motoring time ta upon satisfaction of the increase start condition and the rate value Rup in the form of a map in the ROM (not shown), and reads and sets the rate value Rup corresponding to a given motoring time ta from this map. One example of the relationship between the motoring time ta upon satisfaction of the increase start condition and the rate value Rup is shown in FIG. 9. As illustrated, the rate value Rup is set to provide a larger value with respect to the shorter motoring time ta upon satisfaction of the increase start condition than a value with respect to the longer motoring time ta and is more specifically set to have an increasing tendency With a decrease in motoring time ta upon satisfaction of the increase start condition as a whole. This attributed to the following two reasons. The first reason (1) is that the smaller minimum torque Tspmin (motoring torque Tsp upon satisfaction of the increase start condition) is expected to provide a greater reduction in rotation speed Ne of the engine 22 per unit time and to provide a shorter motoring time ta upon satisfaction of the increase start condition, compared with the larger minimum torque Tspmin. The second reason (2) is that the rate value Rup is set to provide a larger value with respect to the smaller minimum torque Tspmin than a value with respect to the larger minimum torque Tspmin according to the first embodiment. By taking into account these two factors, the rate value Rup is set to provide a larger value with respect to the shorter motoring time ta upon satisfaction of the increase start condition than a value with respect to the longer motoring time ta. This results in providing a larger increment (decrement as the absolute value) of the motoring torque Tsp per unit time with respect to the shorter motoring time ta upon satisfaction of the increase start condition than an increment with respect to the longer motoring time ta in the process of increasing the motoring torque Tsp. As a result, like the first embodiment, this modification also reduces abnormal noise such as gear rattle of the planetary gear 30 and suppresses reverse rotation of the engine 22 in the process of stopping the engine 22.

In the hybrid vehicle 20 of the first embodiment, the rate value Rup is set to provide a larger value with respect to the smaller minimum torque Tspmin (larger absolute value) than a value with respect to the larger minimum torque Tspmin. In the modification, the rate value Rup is set to provide a larger value with respect to the shorter motoring time ta upon satisfaction of the increase start condition than a value with respect to the longer motoring time ta. According to another modification, the rate value Rup may be set to have a tendency based on their combination. More specifically, the rate value Rup may be set to provide a larger value with respect to the smaller minimum torque Tspmin than a value with respect to the larger minimum torque Tspmin and to provide a larger value with respect to the shorter motoring time ta upon satisfaction of the increase start condition than a value with respect to the longer motoring time ta.

In the hybrid vehicle 20 of the first embodiment and its modification, the rate process is performed to change the motoring torque Tsp (torque command Tm1* of the motor MG1) in the process of stopping the engine 22. According to another modification, the motoring torque Tsp may be changed by a gradual changing process other than the rate process, for example, smoothing process using a time constant. In this modification, the time constant maybe set to provide a larger increment (decrement as the absolute value) of the motoring torque Tsp per unit time with respect to the smaller minimum torque Tspmin than an increment with respect to the larger minimum torque Tspmin and/or to provide a larger increment of the motoring torque Tsp per unit time with respect to the shorter motoring time ta upon satisfaction of the increase start condition than an increment with respect to the longer motoring time ta, in the process of increasing the motoring torque Tsp.

### Second Embodiment

The following describes a hybrid vehicle 20B according to a second embodiment of the invention. The hybrid vehicle 20B of the second embodiment has the similar hardware configuration to that of the hybrid vehicle 20 of the first embodiment described above with reference to FIG. 1 and performs similar controls to those of the hybrid vehicle 20 except control in the process of stopping the engine 22 in order to avoid repetition in description, the description on the hardware configuration and the same controls of the hybrid vehicle 20B of the second embodiment is omitted.

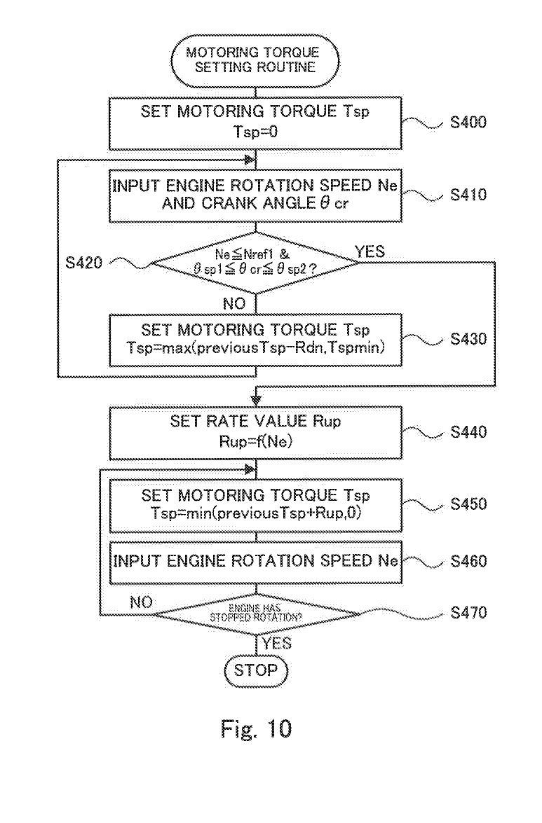

In the hybrid vehicle 20B of the second embodiment, the HVECU 70 performs the stop-time control routine of FIG. 2 described above and a motoring torque setting routine of FIG. 10. The following describes the motoring torque setting routine of FIG. 10.

On start of the motoring torque setting routine of FIG. 10, the HVECU 70 sets the value 0 to the motoring torque Tsp (step S400) and inputs the rotation speed Ne and the crank angle θcr of the engine 22 (step S410), like the processing of steps S200 and S210 of FIG. 5.

The HVECU 70 subsequently refers to the input rotation speed Ne and the input crank angle θcr of the engine 22 to determine whether an increase start condition is satisfied (step S420). According to the second embodiment, the increase start condition is that the rotation speed Ne of the engine 22 becomes equal to or lower than the predetermined rotation speed Nref1 described above and that the crank angle θcr of the engine 22 enters the predetermined range of θsp1 to θsp2 described above.

When the increase start condition is not satisfied at step S420, the HVECU 70 sets the motoring torque Tsp according to Equation (5) given above (step S430) like the processing of step S290 in the routine of FIG. 5 and returns to step S410. The base value Tspmintmp described above is used as the minimum torque Tspmin in Equation (5).

When the increase start condition is satisfied at step S420 as a result of repetition of the processing of steps S410 to S430, the HVECU 70 sets a rate value Rup based on the rotation speed Ne of the engine 22 at that moment (step S440). Like the processing of steps S310 to S330 in the routine of FIG. 5, the HVECU 70 sets the motoring torque Tsp according to Equation (6) given above (step S450), inputs the rotation speed Ne of the engine 22 (step S460) and determines whether the engine 22 has stopped rotation (step S470). When it is determined that the engine 22 has not yet stopped rotation, the HVECU 70 returns to step S450. When it is determined at step S470 that the engine 22 has stopped rotation as a result of repetition of the processing of steps S450 to S470, the HVECU 70 terminates this routine.

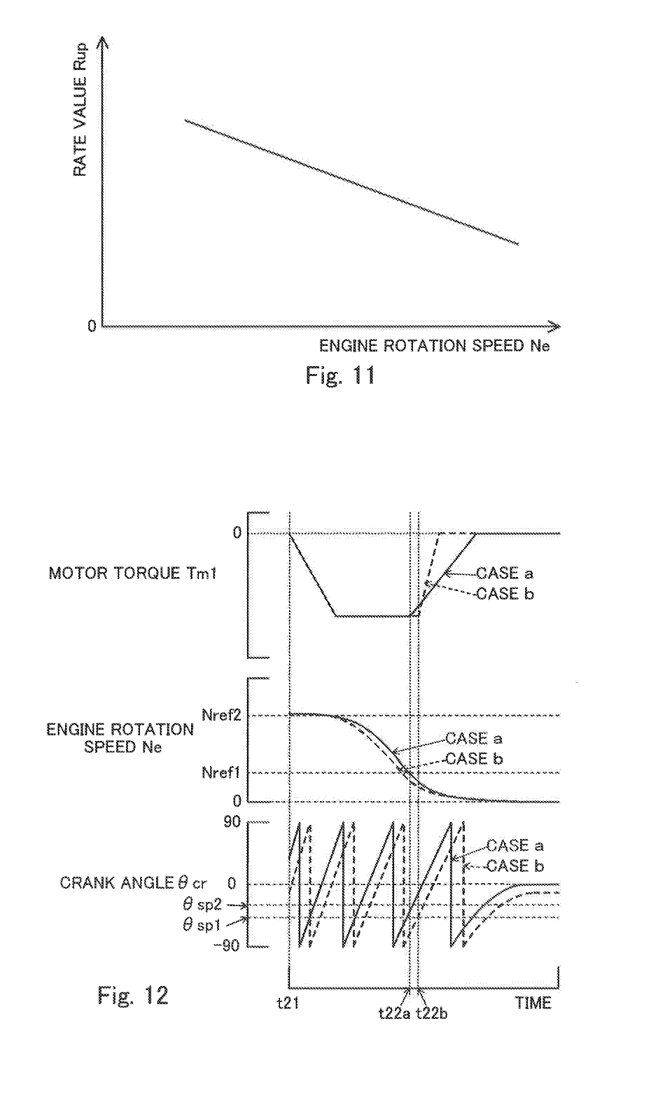

According to the second embodiment, a procedure of setting the rate value Rup specifies and stores in advance a relationship between the rotation speed Ne of the engine 22 upon satisfaction of the increase start condition and the rate value Rup in the form of a map in the ROM (not shown), and reads and sets the rate value Rup corresponding to a given rotation speed Ne from this map. One example of the relationship between the rotation speed Ne of the engine 22 upon satisfaction of the increase start condition and the rate value Rup is shown in FIG. 11. As illustrated, the rate value Rup is set to provide a larger value with respect to the lower rotation speed Ne of the engine 22 upon satisfaction of the increase start condition than a value with respect to the higher rotation speed Ne and is more specifically set to have an increasing tendency with a decrease in rotation speed Ne of the engine 22 upon satisfaction of the increase start condition as a whole. This results in providing a larger increment (decrement as the absolute value) of the motoring torque Tsp per unit time (for example, interval of execution of step S450) with respect to the lower rotation speed Ne of the engine 22 upon satisfaction of the increase start condition than an increment with respect to the higher rotation speed Ne. Setting a relatively small increment of the motoring torque Tsp (torque command Tm1* of the motor MG1) per unit time at the relatively high rotation speed Ne of the engine 22 upon satisfaction of the increase start condition suppresses the motoring torque Tsp from approaching to the value 0 when the rotation speed Ne of the engine 22 is a relatively high rotation speed in a range of not higher than the predetermined rotation speed Nref1 (rotation speed relatively close to the resonance range of the engine). This reduces abnormal noise such as gear rattle of the planetary gear 30 due to a torque caused by, for example, torsion of the damper 28. Setting a relatively large increment of the motoring torque Tsp per unit time at the relatively low rotation speed Ne of the engine 22 upon satisfaction of the increase start condition, on the other hand, suppresses the rotation speed Ne of the engine 22 from decreasing across the value 0 to a negative value or in other words, suppresses reverse rotation of the engine 22.

FIG. 12 is a chart showing one example of time changes of the torque Tm1 of the motor MG1 and the rotation speed Ne and the crank angle θcr of the engine 22 in the process of stopping the engine 22. In the chart, solid-line curves indicate a case a the increase start condition is satisfied at a time t22a), and broken-line curves indicate a case b (the increase start condition is satisfied at a time t22b). As shown by the solid-line curves and the broken-line curves, when the stop condition of the engine 22 is satisfied at a time t21, the procedure performs the rate process using the rate value Rdn to decrease the torque Tm1 of the motor MG1 from the value 0 toward the minimum torque Tspmin (=Tspmintmp) (increase as the absolute value) and keep the torque Tm1 at the minimum torque Tspmin. The increase start condition (condition that the rotation speed Ne of the engine 22 becomes equal to or lower than the predetermined rotation speed Nref1 and that the crank angle θcr of the engine 22 enters the predetermined range of θsp21 to θsp22) is satisfied at the time t22a in the case a and at the time t22b in the case b. The procedure then waits until the engine 22 stops rotation, while performing the rate process using the rate value Rup to increase the torque Tm1 of the motor MG1 from the minimum torque Tspmin to the value 0 (decrease as the absolute value). According to the second embodiment, the rate value Rup is set to provide a larger value with respect to the lower rotation speed Ne of the engine 22 upon satisfaction of the increase start condition than a value with respect to the higher rotation speed Ne. This reduces abnormal noise such as gear rattle of the planetary gear 30 and suppresses reverse rotation of the engine 22 in the process of stopping the engine 22.

As described above, the hybrid vehicle 20B of the second embodiment starts increasing the motoring torque Tsp (torque command Tm1* of the motor MG1) from the negative minimum torque Tspmin, upon satisfaction of the increase start condition that the rotating speed Ne of the engine 22 becomes equal to or lower than the predetermined rotation speed Nref1 and that the crank angle θcr of the engine 22 enters the predetermined range of θsp21 to θsp22, in the process of stopping the engine 22. The hybrid vehicle 20B increases the motoring torque Tsp (decreases as the absolute value) by the rate process using the rate value Rup that is set to provide a larger value with respect to the lower rotation speed Ne of the engine 22 upon satisfaction of the increase start condition than a value with respect to the higher rotation speed Ne. This results in providing a larger increment (decrement as the absolute value) of the motoring torque Tsp per unit time with respect to the lower rotation speed Ne of the engine 22 upon satisfaction of the increase start condition than an increment with respect to the higher rotation speed Ne in the process of increasing the motoring torque Tsp. As a result, this reduces abnormal noise such as gear rattle of the planetary gear 30 and suppresses reverse rotation of the engine 22 in the process of stopping the engine 22.

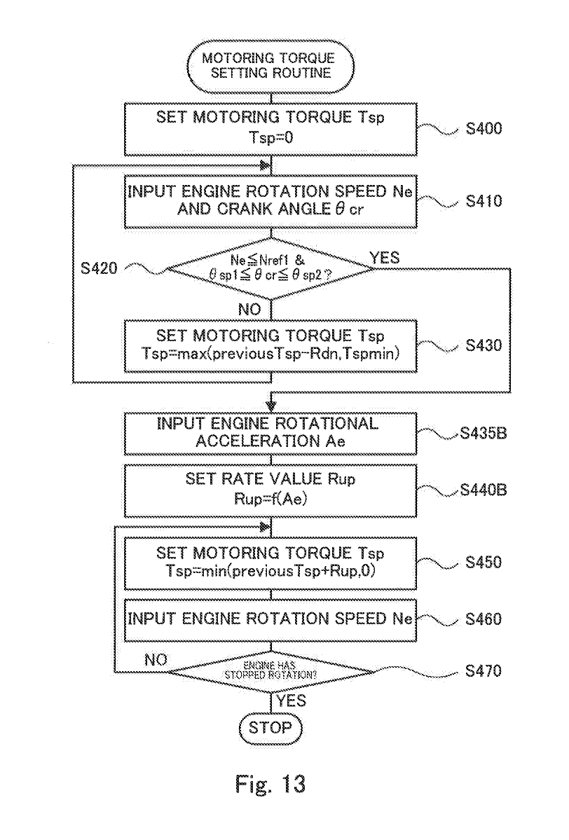

The hybrid vehicle 20B of the second embodiment performs the motoring torque setting routine of FIG. 10 in the process of stopping the engine 22. According to modifications, the hybrid vehicle may perform one of motoring torque setting routines of FIGS. 13 to 15. The following sequentially describes the motoring torque setting routines of the modifications.

The motoring torque setting routine of FIG. 13 is described. The motoring torque setting routine of FIG. 13 is similar to the motoring torque setting routine of FIG. 10, except replacement of step S440 with steps S435B and 440B. The like steps in the motoring torque setting routine of FIG. 13 to those in the motoring torque setting routine of FIG. 10 are expressed by the like step numbers and are not specifically described.

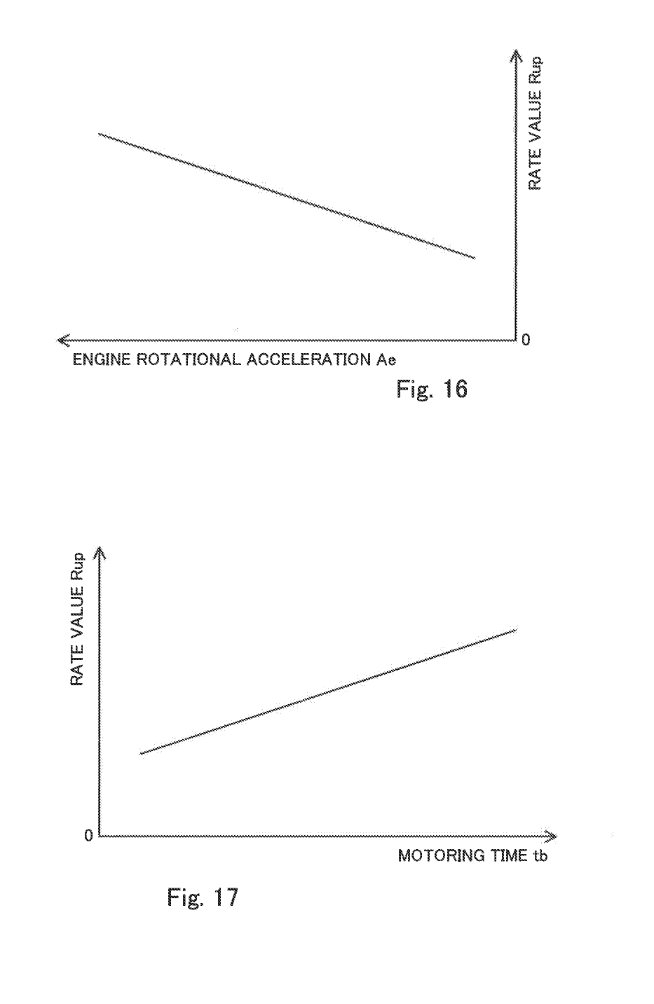

In the motoring torque setting routine of FIG. 13, the HVECU 70 performs the processing of steps S400 and repeatedly performs the processing of steps S410 to S430. When the increase start condition is satisfied at step S420 as a result of repetition of the processing of steps S410 to S430, the HVECU 70 inputs a rotational acceleration Ae of the engine 22 (step S435B), sets a rate value Rup based on the input rotational acceleration Ae of the engine 22 (rotational acceleration Ae of the engine 22 upon satisfaction of the increase start condition (step S440B), and performs the processing of and after step S450. The rotational acceleration Ae of the engine 22 may be calculated from the current value and the previous value of the rotation speed Ne of the engine 22. According to this modification, a procedure of setting the rate value Rup specifies and stores in advance a relationship between the rotational acceleration Ae of the engine 22 upon satisfaction of the increase start condition and the rate value Rup in the form of a map in the ROM (not shown), and reads and sets the rate value Rup corresponding to a given rotational acceleration Ae from this map. One example of the relationship between the rotational acceleration Ae of the engine 22 upon satisfaction of the increase start condition and the rate value Rup is shown in FIG. 16. As illustrated, the rate value Rup is set to provide a larger value with respect to the lower rotational acceleration Ae of the engine 22 (value in a negative range, i.e., larger absolute value) upon satisfaction of the increase start condition than a value with respect to the higher rotational acceleration Ae and is more specifically set to have an increasing tendency with a decrease in rotational acceleration Ae of the engine 22 upon satisfaction of the increase start condition as a whole. This is attributed to the following two reasons The first reason (1) is that the lower rotational acceleration Ae of the engine 22 (larger absolute value) upon satisfaction of the increase start condition is expected to provide a greater reduction in rotation speed Ne of the engine 22 per unit time and to provide a lower rotation speed Ne of the engine 22 upon satisfaction of the increase start condition, compared with the higher rotational acceleration Ae. The second reason (2) is that the rate value Rup is set to provide a larger value with respect to the lower rotation speed Ne of the engine 22 upon satisfaction of the increase start condition than a value with respect to the higher rotation speed Ne according to the second embodiment. By taking into account these two factors, the rate value Rup is set to provide a larger value with respect to the lower rotational acceleration Ae of the engine 22 upon satisfaction of the increase start condition than a value with respect to the higher rotational acceleration Ae. This results in providing a larger increment (decrement as the absolute value) of the motoring torque Tsp per unit time with respect to the lower rotational acceleration Ae of the engine 22 upon satisfaction of the increase start condition than an increment with respect to the higher rotational acceleration Ae. As a result, like the second embodiment, this modification also suppresses reverse rotation of the engine 22 and reduces abnormal noise such as gear rattle of the planetary gear 30 in the process of stopping the engine 22.

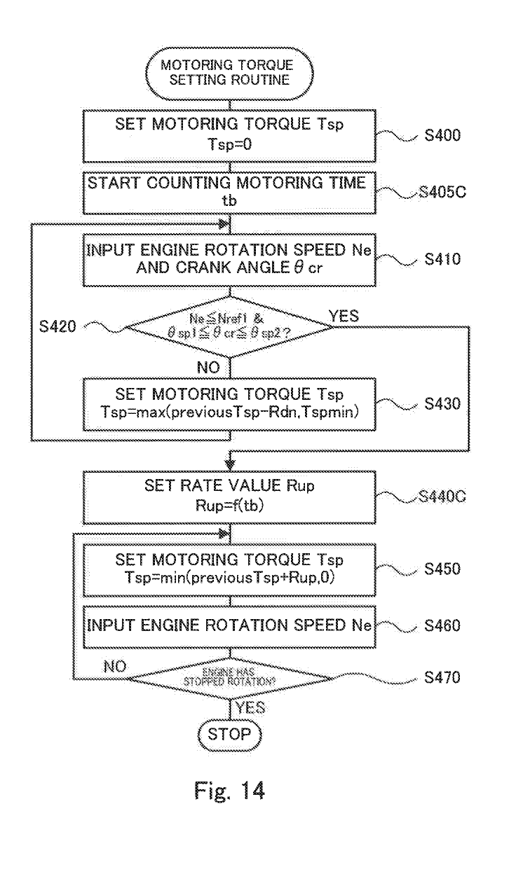

The motoring torque setting routine of FIG. 14 is described. The motoring torque setting routine of FIG. 14 is similar to the motoring torque setting routine of FIG. 10, except addition of step S405C and replacement of step S440 with step S440C. The like steps in the motoring torque setting routine of FIG. 14 to those in the motoring torque setting routine of FIG. 10 are expressed by the like step numbers and are not specifically described.

In the motoring torque setting routine of FIG. 14, after the processing of step S400, the HVECU 70 starts counting a motoring time tb (step S405C). The motoring time tb denotes a time period since a start of the stop-time control by the motor MG1 (since a start of execution of the routines of FIGS. 2 and 14).

When the increase start condition is satisfied at step S420 as a result of repetition of the processing of steps S410 to S430, the HVECU 70 set the rate value Rup based on the motoring time tb at that moment (time period until the increase start condition is satisfied since a start of the stop-time control by the motor MG1) (step S440C) and performs the processing of and after step S450. According to this modification, a procedure of setting the rate value Rup specifies and stores in advance a relationship between the motoring time tb upon satisfaction of the increase start condition and the rate value Rup in the form of a map in the ROM (not shown), and reads and sets the rate value Rup corresponding to a given motoring time tb from this map. One example of the relationship between the motoring time tb upon satisfaction of the increase start condition and the rate value Rup is shown in FIG. 17 illustrated, the rate value Rup is set to provide a larger value with respect to the longer motoring time tb upon satisfaction of the increase start condition than a value with respect to the shorter motoring time tb and is more specifically set to have an increasing tendency with an increase in motoring time tb upon satisfaction of the increase start condition as a whole. This is attributed to the following two reasons. The first reason (1) is that the longer motoring time tb upon satisfaction of the increase start condition is expected to provide a lower rotation speed Ne of the engine 22 at that moment than the rotation speed Ne at the shorter motoring time tb. The second reason (2) is that the rate value Rup is set to provide a larger value with respect to the lower rotation speed Ne of the engine 22 upon satisfaction of the increase start condition than a value with respect to the higher rotation speed Ne according to the second embodiment. By taking into account these two factors, the rate value Rup is set to provide a larger value with respect to the longer motoring time tb upon satisfaction of the increase start condition than a value with respect to the shorter motoring time tb. This results in providing a larger increment (decrement as the absolute value) of the motoring torque Tsp per unit time with respect to the longer motoring time tb upon satisfaction of the increase start condition than an increment with respect to the shorter motoring time tb. As a result, like the second embodiment, this modification also suppresses reverse rotation of the engine 22 and reduces abnormal noise such as gear rattle of the planetary gear 30 in the process of stopping the engine 22.

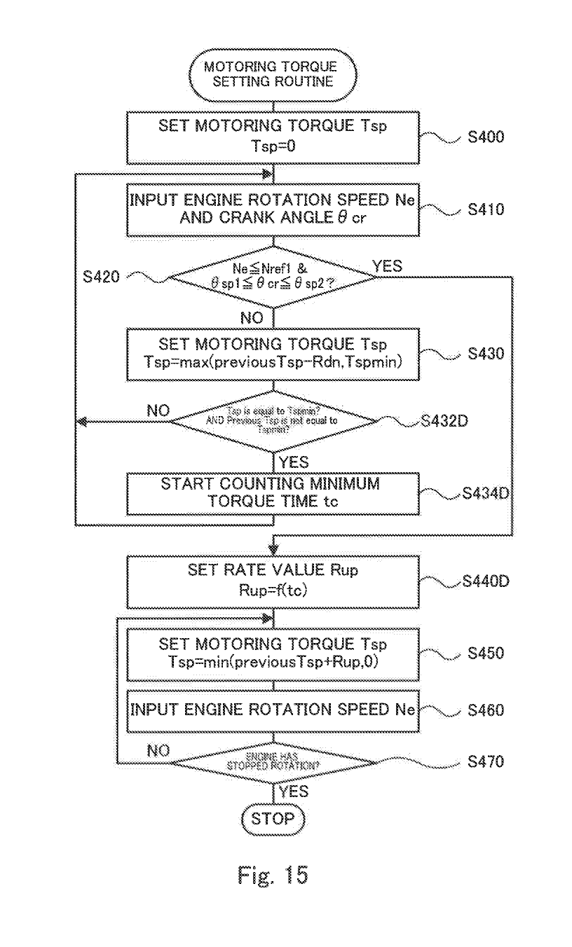

The motoring torque setting routine of FIG. 15 is described. The motoring torque setting routine of FIG. 15 is similar to the motoring torque setting routine of FIG. 10, except addition of steps S432D and 434D and replacement of step S440 with step S440D. The like steps in the motoring torque setting routine of FIG. 15 to those in the motoring torque setting routine of FIG. 10 are expressed by the like step numbers and are not specifically described.

In the motoring torque setting routine of FIG. 15, after setting the motoring torque Tsp (step S430), the HVECU 70 determines whether it is immediately after a decrease of the motoring torque Tsp to the minimum torque Tspmin using the current motoring torque Tsp and the previous motoring torque (previous Tsp) (step S432D).

When the current motoring torque Tsp is equal to the minimum torque Tspmin and the previous motor torque (previous Tsp) is not equal to the minimum torque Tspmin, the HVECU 70 determines that it is immediately after a decrease of the motoring torque Tsp to the minimum torque Tspmin, starts counting a minimum torque time tc (step S434D) and returns to step S410. The minimum torque time tc denotes a time period since a decrease of the motoring torque Tsp to the minimum torque Tspmin.

When the current motoring torque Tsp is not equal to the minimum torque Tspmin or when the previous motoring torque (previous Tsp) is equal to the minimum torque Tspmin, on the other hand, the HVECU 70 determines that it is not immediately after a decrease of the motoring torque Tsp to the minimum torque Tspmin and returns to step S410 without the processing of step S434D.

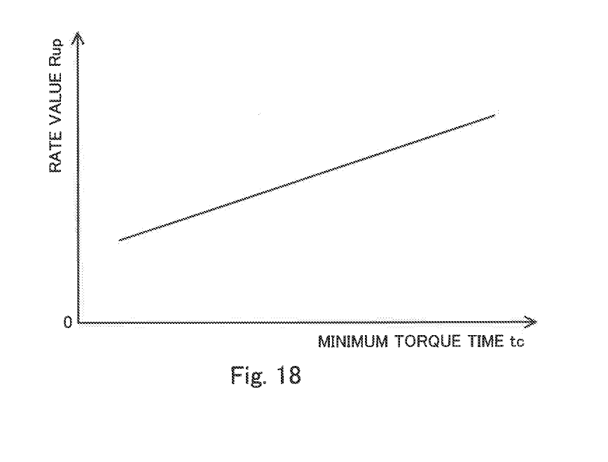

When the increase start condition is satisfied at step S420, the HVECU 70 sets the rate value Rup based on the minimum torque time tc at that moment (time period until satisfaction of the increase start condition since a decrease of the motoring torque Tsp to the minimum torque Tspmin (step S440D) and performs the processing of and after step S450. According to this modification, a procedure of setting the rate value Rup specifies and stores in advance a relationship between the minimum torque time tc upon satisfaction of the increase start condition and the rate value Rup in the form of a map in the ROM (not shown), and reads and sets the rate value Rup corresponding to a given minimum torque time tc from this map. One example of the relationship between the minimum torque time tc upon satisfaction of the increase start condition and the rate value Rup is shown in FIG. 18. As illustrated, the rate value Rup is set to provide a larger value with respect to the longer minimum torque time tc upon satisfaction of the increase start condition than a value with respect to the shorter minimum torque time tc and is more specifically set to have an increasing tendency with an increase in minimum torque time tc upon satisfaction of the increase start condition as a whole. This is attributed to the following two reasons. The first reason (1) is that the longer minimum torque time tc upon satisfaction of the increase start condition is expected to provide a lower rotation speed Ne of the engine 22 at that moment than the rotation speed Ne at the shorter minimum torque time tc. The second reason (2) is that the rate value Rup is set to provide a larger value with respect to the lower rotation speed Ne of the engine 22 upon satisfaction of the increase start condition than a value with respect to the higher rotation speed Ne according to the second embodiment. By taking into account these two factors, the rate value Rup is set to provide a larger value with respect to the longer minimum torque time tc upon satisfaction of the increase start condition than a value with respect to the shorter minimum torque time tc. This results in providing a larger increment (decrement as the absolute value) of the motoring torque Tsp per unit time with respect to the longer minimum torque time tc upon satisfaction of the increase start condition than an increment with respect to the shorter minimum torque time tc. As a result, like the second embodiment, this modification also suppresses reverse rotation of the engine 22 and reduces abnormal noise such as gear rattle of the planetary gear 30 in the process of stopping the engine 22.

In the hybrid vehicle 20B of the second embodiment, the rate up Rup is set to provide a larger value with respect to the lower rotation speed Ne of the engine 22 upon satisfaction of the increase start condition than a value with respect to the higher rotation speed Ne. In the modifications, the rate value Rup is set to provide a larger value with respect to the lower rotational acceleration Ae of the engine 22 upon satisfaction of the increase start condition than a value with respect to the higher rotational acceleration Ae, to provide a larger value with respect to the longer motoring time tb upon satisfaction of the increase start condition than a value with respect to the shorter motoring time tc, or to provide a larger value with respect to the longer minimum torque time tc upon satisfaction of the increase start condition than a value with respect to the shorter minimum torque time tc. According to another modification, the rate value Rup may be set to have a tendency based on some or all of their combinations. For example, the rate value Rup may be set to provide a larger value with respect to the lower rotation speed Ne of the engine 22 upon satisfaction of the increase start condition than a value with respect to the higher rotation speed Ne and to provide a larger value with respect to the longer motoring time tb upon satisfaction of the increase start condition than a value with respect to the shorter motoring time tb.

In the hybrid vehicle 20B of the second embodiment and its modifications, the rate process is performed to change the motoring torque Tsp (torque command Tm1* of the motor MG1) in the process of stopping the engine 22. According to another modification, the motoring torque Tsp may be changed by a gradual changing process other than the rate process, for example, smoothing process using a time constant. In this modification, the time constant may be set to provide a larger increment (decrement as the absolute value) of the motoring torque Tsp per unit time with respect to the lower rotation speed Ne of the engine 22 upon satisfaction of the increase start condition than an increment with respect to the higher rotation speed Ne, and/or to provide a larger increment of the motoring torque Tsp per unit time with respect to the lower rotational acceleration Ae upon satisfaction of the increase start condition than an increment with respect to the higher rotational acceleration Ae, and/or to provide a larger increment of the motoring torque Tsp per unit time with respect to the longer motoring time tb upon satisfaction of the increase start condition than an increment with respect to the shorter motoring time tb, and/or to provide a larger increment of the motoring torque Tsp per unit time with respect to the longer minimum torque time tc upon satisfaction of the increase start condition than an increment with respect to the shorter minimum torque time tc, in the process of increasing the motoring torque Tsp.

The hybrid vehicles 20 and 20B of the first and the second embodiments use the four-cylinder engine 22 but may use an engine having another number of cylinders, for example, six-cylinder, eight-cylinder or twelve-cylinder engines.

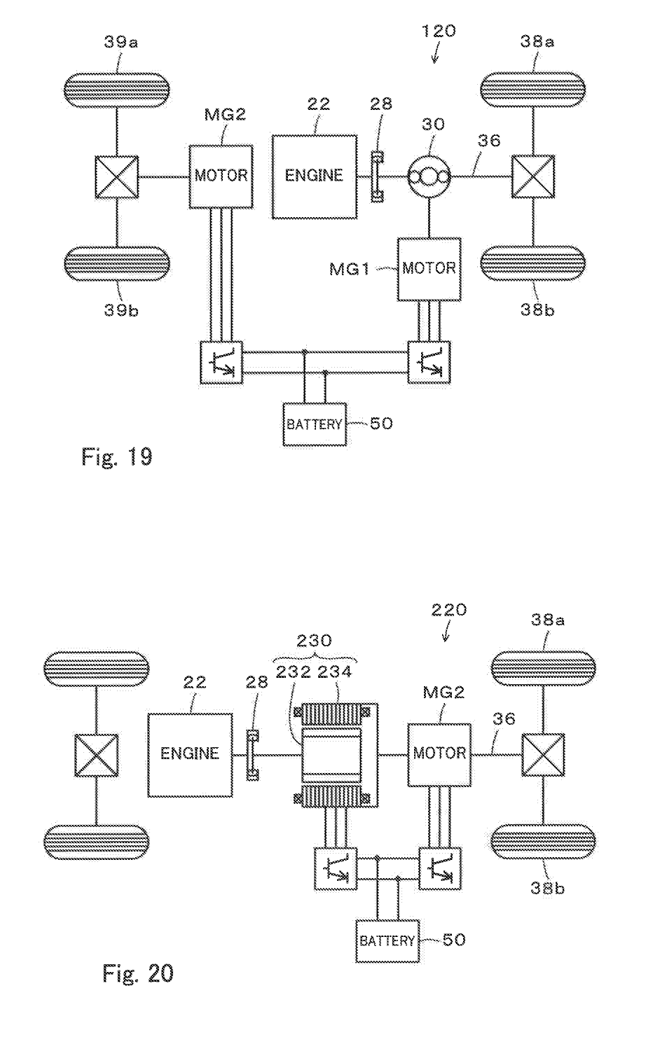

In the hybrid vehicles 20 and 20B of the first and the second embodiments, the power from the motor MG2 is output to the driveshaft 36 linked with the drive wheels 38a and 38b. As illustrated in a hybrid vehicle 120 of a modification of FIG. 19, however, the power from a motor MG2 may be output to an axle (axle linked with wheels 39a and 39b in FIG. 19) that is different from an axle connected with a driveshaft 36 (axle linked with drive wheels 38a and 38b).

In the hybrid vehicles 20 and 20B of the first and the second embodiments, the power from the engine 22 is output via the planetary gear 30 to the driveshaft 36 linked with the drive wheels 38a and 38b. As illustrated in FIG. 20, however, a hybrid vehicle 220 of another modification may be provided with a pair-rotor motor 230 that includes an inner rotor 232 connected with a crankshaft of an engine 22 via a damper 28 and an outer rotor 234 connected with a driveshaft 36 linked with drive wheels 38a and 38b. The pair-rotor motor 230 is configured to transmit part of the power from the engine 22 to the driveshaft 36 and convert the remaining part of the power into electric power.

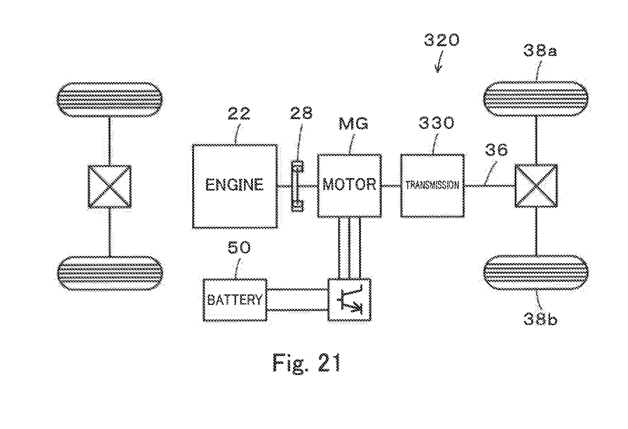

In the hybrid vehicles 20 and 20B of the first and the second embodiments, the power from the engine 22 is output via the planetary gear 30 to the driveshaft 36 connected with the drive wheels 38a and 38b, while the power from the motor MG2 is also output to the driveshaft 36. As illustrated in a hybrid vehicle 320 of another modification of FIG. 21, however, a motor MG may be connected via a transmission 330 with a driveshaft 36 linked with drive wheels 38a and 38b, and an engine 22 may be connected via a damper 28 with a rotating shaft of the motor MG. In this configuration, the power from the engine 22 is output to the driveshaft 36 via the rotating shaft of the motor MG and the transmission 330, while the power from the motor MG is output via the transmission 330 to the driveshaft 36.

In the first hybrid vehicle of the invention, the first torque may he a torque adjusted according to the crank angle of the engine when the rotation speed of the engine decreases to or below a second predetermined rotation speed that is higher than the predetermined rotation speed.

The first or the second hybrid vehicle of the invention may include a planetary gear that is configured to have three rotational elements respectively connected with a driveshaft linked with the axle, the predetermined shaft and a rotating shaft of the motor and a second motor that is configured to transmit electric power to and from the battery and input and output power from and to the driveshaft. The hybrid vehicle of this configuration performs the control described above to reduce abnormal noise such as gear rattle of the planetary gear as the mechanical structure and to suppress reverse rotation of the engine.

The following describes the correspondence relationship between the primary components of the embodiments and the primary components of the invention described in Summary of Invention. The engine 22 of the embodiment corresponds to the “engine”; the motor MG1 corresponds to the “motor”; the battery 50 corresponds to the “battery”; and the HVECU 70 and the motor ECU 40 correspond to the “controller”.

The correspondence relationship between the primary components of the embodiment and the primary components of the invention, regarding which the problem is described in Summary of Invention, should not be considered to limit the components of the invention, regarding which the problem is described in Summary of Invention, since the embodiment is only illustrative to specifically describes the aspects of the invention, regarding which the problem is described in Summary of Invention. In other words, the invention, regarding which the problem is described in Summary of Invention, should be interpreted on the basis of the description in the Summary of invention, and the embodiment is only a specific example of the invention, regarding which the problem is described in Summary of Invention.

The embodiment discussed above is to be considered in all aspects as illustrative and not restrictive. There may be many modifications, changes, and alterations without departing from the scope or spirit of the main characteristics of the present invention. The scope and spirit of the present invention are indicated by the appended claims, rather than by the foregoing description.

### INDUSTRIAL APPLICABILITY

The invention is applicable to, for example, manufacturing industries of hybrid vehicles.

1. A hybrid vehicle, comprising:
an engine that is configured to have an output shaft connected via a torsion element with a predetermined shaft on a side of an axle;
a motor that is configured to input and output power from and to the predetermines shaft;
a battery that is configured to transmit electric power to and from the motor; and
a controller that is configured to perform a stop-time control by the motor in a process of stopping the engine, the stop-time control controlling the motor to output a first torque in a direction of reducing rotation speed of the engine until satisfaction of a condition that the rotation speed of the engine becomes equal to or lower than a predetermined rotation speed, and controlling the motor to decrease magnitude of torque output from the motor from magnitude of the first torque after satisfaction of the condition, wherein
the first torque is a torque adjusted such that a crank angle of the engine enters a predetermined range upon satisfaction of the condition, and
after satisfaction of the condition, the stop-time control controls the motor such as to provide a larger decrement in magnitude of the torque output from the motor per unit time with respect to a larger magnitude of the first torque than a decrement with respect to a smaller magnitude of the first torque, and/or such as to provide a larger decrement in magnitude of the torque output from the motor per unit time with respect to a shorter time period until satisfaction of the condition since a start of the stop-time control than a decrement with respect to a longer time period.

2. A hybrid vehicle, comprising:
an engine that is configured to have an output shaft connected via a torsion element with a predetermined shaft on a side of an axle;
a motor that is configured to input and output power from and to the predetermines shaft;
a battery that is configured to transmit electric power to and from the motor; and
a controller that is configured to perform a stop-time control by the motor in a process of stopping the engine, the stop-time control controlling the motor to output a predetermined torque in a direction of reducing rotation speed of the engine until satisfaction of a condition that the rotation speed of the engine becomes equal to or lower than a predetermined rotation speed and that a crank angle of the engine enters a predetermined range, and controlling the motor to decrease magnitude of torque output from the motor from magnitude of the predetermined torque after satisfaction of the condition, wherein
after satisfaction of the condition, the stop-time control controls the motor such as to provide a larger decrement in magnitude of the torque output from the motor per unit time with respect to a lower rotation speed or a lower rotational acceleration of the engine upon satisfaction of the condition than a decrement with respect to a higher rotation speed or a higher rotational acceleration, and/or such as to provide a larger decrement in magnitude of the torque output from the motor per unit time with respect to a longer time period until satisfaction of the condition since a start of the stop-time control than a decrement with respect to a shorter time period.

3. The hybrid vehicle according to claim 1, further comprising:
a planetary gar that is configured to have three rotational elements respectively connected with a driveshaft linked with the axle, the predetermined shaft and a rotating shaft of the motor; and
a second motor that is configured to transmit electric power to and from the battery and input and output power from and to the driveshaft.

4. The hybrid vehicle according to claim 2, further comprising:
a planetary gar that is configured to have three rotational elements respectively connected with a driveshaft linked with the axle, the predetermined shaft and a rotating shaft of the motor; and
a second motor that is configured to transmit electric power to and from the battery and input and output power from and to the driveshaft.
